(19) United States
(12) Patent Application Publication
(10) Pub. No.: US 2003/0065690 A1
(43) Pub. Date: Apr. 3, 2003

(54) Regulatory online management system

(76) Inventor: J. Roger Kelley, Humble, TX (US)

Correspondence Address: Robert C. Curfiss, Jackson Walker L.L.P., Suite 2100, 112 E. Pecan,, San Antonio, TX, 78205, US

(21) Appl. No.: 09/849,078

(22) Filed: May 4, 2001

(51) Int. Cl. G06F 1/00

(52) U.S. Cl. 708/100

(57) ABSTRACT

An on-line accessible information management system for management of environmental, safety and regulatory compliance issues provides smart links to major information centers for any industry to provide easy access to relevant information. The system of the subject invention is designed to assist the user in determining the regulatory requirements of a relevant industry, provide the resources for complying with the requirements, prepare reports, and electronically submit the reports to agencies having on-line reporting capability. The system is secure for each user, but will permit the sharing of public data in order to increase each user's data base. The system of the invention also includes a digital library providing each user with a full complement of regulatory information and research services. The system provides data collection, calculation, and reporting capabilities for environmental and regulatory compliance. Client data is collected from a variety of sources and locations by a data collection module through a variety of means and is entered into the system database. A companion database, the system library, is maintained by an automated harvesting engine which updates the library with the latest statutory and regulatory information from all levels of government, as well as any forms or other necessary information. The system library is also populated with various constants and curves which are used in calculations.

### BACKGROUND OF THE INVENTION

1. Field of Invention

The subject invention is generally related to automated methods for collecting data and generating reports relating to the data and is more specifically directed to a method for the on-line development and collection of data required to be submitted to regulatory agencies and the generation and submission of reports to such agencies

2. Description of the Prior Art

It is widely recognized that most industries find themselves buried in a sea of regulatory compliance requirements. As industry is faced with this myriad of government regulatory requirements, the application and implementation has resulted in a significant impact to profitability. In response to this challenge, industry in general has been required to establish entire departments within their organizations in order to comply with these regulations, ranging in application from basic accounting and financial procedures to the very complex and costly environmental, industrial hygiene, and safety regulations. The staff required to deal with these government requirements include accountants, lawyers, medical doctors, engineers, chemists and other associated support staff.

As an example, there are over 8,000 producers of oil and gas in the United States, operating approximately 884,000 oil and gas wells. Each of these wells has its own specific and definite regulatory requirements. At present, the operator of each well must collect the critical information from each well, assimilate it into a data base and develop the required reports for each of the various regulatory agencies at both the state and national level. The task is expensive, time consuming and inefficient, at best.

There have been numerous attempts to automate this process. However, prior art system are not compatible with one another and, while each may be useful for a portion of the various required tasks there are not any systems that provide a comprehensive method for collecting, assimilating and storing data and generating therefrom the required reports for the various regulatory agencies.

### SUMMARY OF INVENTION

The subject invention is directed to a method for collecting, assimilating and utilizing data from a variety of sources for determining the regulatory requirements and for generating the related compliance reports for an industry. In the preferred embodiment of the invention, the method comprises the steps of collecting external data for compliance requirements of a compliance model, collecting data from a user, assimilating the external data and the user data in a processor to determine compliance by the user, and automatically generating a report unique to the user data containing required compliance information.

One aspect of the subject invention is directed to an on-line accessible information management system designed to assist most industries in worldwide management of environmental, safety and regulatory compliance issues. It is intended to offer “one-stop shopping” for regulatory compliance and represents a substantial savings in costs and time over traditional means for complying with government regulatory reporting requirements. The subject invention is on-line and provides smart links to major information centers for any industry to provide easy access to relevant information. The system of the subject invention is designed to operate as an on-line consultant for assisting the user in determining the regulatory requirements of a relevant industry, providing the resources for complying with the requirements, preparing reports, and electronically submitting the reports to agencies having on-line reporting capability.

The system is secure for each user, but will permit the sharing of public data in order to increase each user's data base. The system of the invention also includes a digital library providing each user with a full complement of regulatory information and research services. Specifically, the subject invention is directed to a convenient, cost effective method for assessing regulatory requirements, researching various databases to meet the requirements and preparing and submitting required reports. In a nutshell, the subject invention provides data collection, calculation, and reporting capabilities for environmental and regulatory compliance.

The subject invention is an on-line system designed to assist companies in managing their environmental, safety and regulatory compliance requirements. The system enables a user to assess the compliance requirements for a particular operation, and once the requirements are defined, permit the tools necessary to perform the appropriate regulatory compliance tasks. The information and tools consist of explanations of the regulations, text of regulations with appropriate annotations, information regarding forms, fees and penalties, and the like, agency contacts and compliance procedures. The system is designed to perform the calculations required to complete the regulatory filings and then populate the reporting forms with specific results unique to the user.

As an example, an operator of an oil well will be required to determine the air compliance of a production compressor. Using the system of the subject invention, the operator will initially log on to the system to determine the related regulatory compliance requirements. He would access the “air module” of the system and enter his specific facility and equipment, i.e. location, equipment, specifications and the like. The system then provides the user with a list of applicable regulations for the compressor stations for that specific location and guides the user through the required steps for reporting the regulatory performance of the facility, including the automated processing of forms and reports, and in many cases the electronic submission of same.

Client data is collected from a variety of sources and location by a data collection module through a variety of means and is entered into the system database. A companion database, the system library, is maintained by an automated harvesting engine which updates the library with the latest statutory and regulatory information from all levels of government, as well as any forms or other necessary information. The system library is also populated with various constants and curves which are used in calculations.

The subject invention contains a number of calculation modules. Each calculation module is designed to take the appropriate client data stored in the system database and use that data as the input to a series of calculations that are necessary for the generation of various required reports. Each of these calculation modules may have one or more submodules and may generate several different outputs or reports. These reports are sent either electronically or on paper to the various agencies and departments that require them.

It is, therefore, an object and feature of the subject invention to provide a fully-integrated, on-line compliance system for regulated industries, including, but not limited to oil and gas, exploration and production, refining, manufacturing and retail in the energy and power exploration, development, production, and distribution industries, medical, banking and finance industries.

It is a further object and feature of the subject invention to provide a compliance system for regulated industries using a combination of full-featured, commerce-enabled, interactive web site along with offline data entry capability.

It is also an object and feature of the subject invention to provide method for collecting, assimilating, storing and distributing data required for regulatory compliance.

It is another object and feature of the subject invention to provide a method for generating reports required for regulatory compliance.

It is also an object and feature of the subject invention to provide a method for on-line, electronic submission of required regulatory compliance reports.

Other objects and features of the invention will be readily apparent from the accompanying drawing and detailed description of the preferred embodiments.

### BRIEF DESCRIPTION OF THE DRAWINGS

FIG. 1 is a system overview.

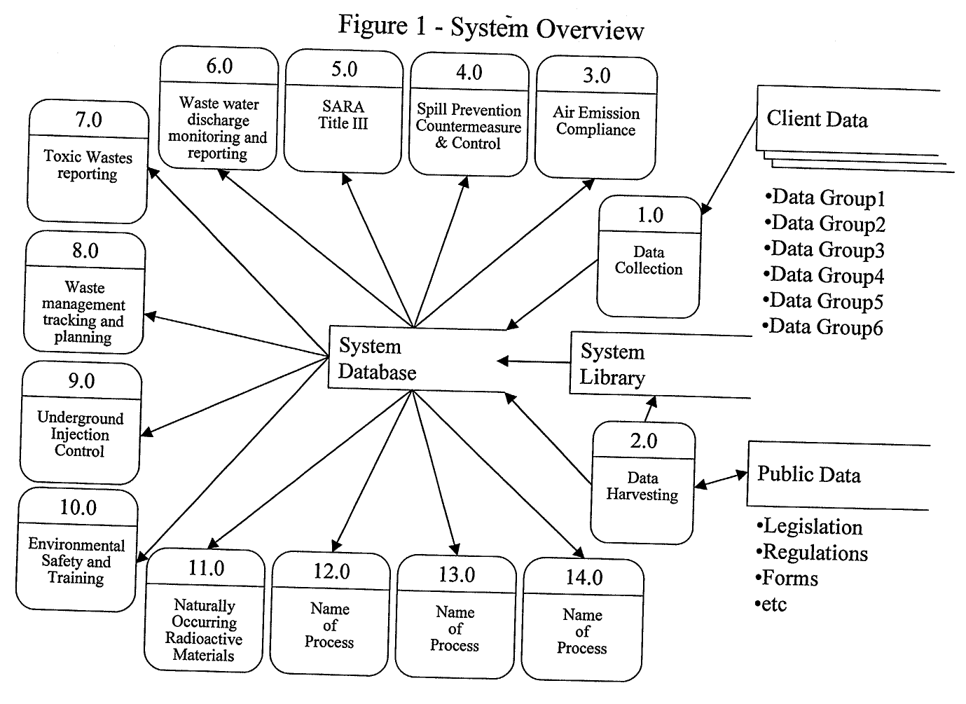

FIG. 2 shows detail of a sample air emission compliance module.

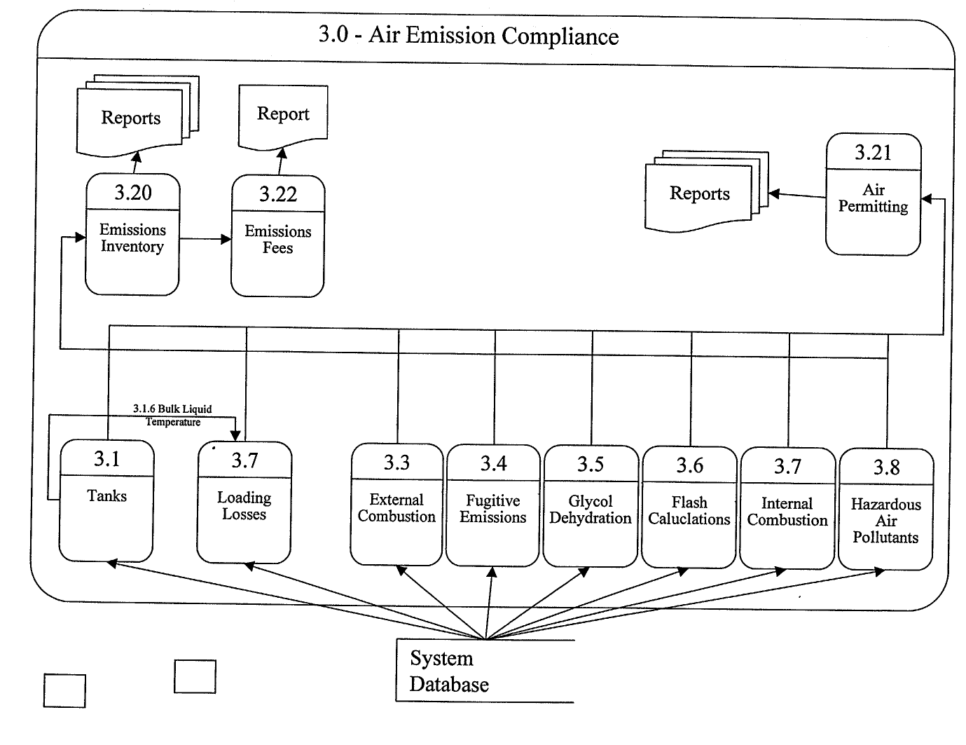

### DESCRIPTION OF THE PREFERRED EMBODIMENT

The subject invention is directed to a system for collecting data from a plurality of public and private sources, merging the data to determine a regulation compliance model for the data, developing a compliance report for the data and electronically or manually submitting the report to the appropriate regulatory agency. An exemplary module is disclosed in detail herein for environmental compliance. The same methodology may be used for other regulatory compliance as well and the disclosure should not be considered as limited to environmental compliance schemes.

In the exemplary embodiment, the Data Collection Module (1.0) collects the data from the clients from a variety of sources and through a variety of means, and the data is then loaded into the System Database. The System Database stores all of the client data, organized by client, location, and equipment identifiers. The System Library contains two primary types of information. The first includes engineering constants and other constants and curves that are used in the various calculations. These are pre-loaded into the system and do not change. The second type of information is likely to change over time and is therefore constantly maintained and updated by an automated harvesting engine module (2.0) supplemented by human effort.

This information includes the latest statutory and regulatory information from all levels of government, as well as any forms or other necessary information for environmental compliance or reporting.

The Air Emission Compliance module (3.0) contains twelve (12) submodules. Eight (8) submodules obtain input data from the System Database and perform a variety of calculations. The remaining three (3) modules take the output from those modules and use them as inputs for generating reports. The submodules operate as follows:

1. Tanks Submodule (3.1)

This submodule calculates hydrocarbon emissions from the crude oil storage tanks according to EPA Document AP-42, Compilation of Air Pollutant Emission Factors, Volume I, Supplement E: Stationary Point and Area Sources, Chapter 12, Section 12.3-1 dated October 1992.

The primary calculation formulas are:

L_{T}=L_{S}+L_{W} (3.1.1)

L_{S}=365V_{V}W_{V}K_{E}K_{S} (3.1.2)

$${V}_{V} = \frac{π}{4} {D}^{2} ( {H}_{S} - {H}_{L} + {H}_{RO} ) \qquad \text{(3.1.3)}$$

$${W}_{V} = \frac{{M}_{V} {P}_{VA}}{{RT}_{LA}} \qquad \text{(3.1.4)}$$

T_{LA}=0.044T_{AA}+0.56T_{B}+0.0079aI (3.1.5)

T_{B}=T_{AA}+6a−1 (3.1.6)

$${K}_{E} = \frac{{dT}_{V}}{{T}_{LA}} + \frac{{dP}_{V} - {dP}_{B}}{{P}_{A} - {P}_{VA}} \qquad \text{(3.1.7)}$$

dT_{V}=0.072d_{TA}+0.028I (3.1.8)

$${K}_{S} = \frac{1}{1 + 0.053 {P}_{VA} {H}_{VO}} \qquad \text{(3.1.9)}$$

H_{VO}=H_{S}−H_{L}+H_{RO} (3.1.10)

L_{W}=0.0010M_{V}P_{VA}QK_{N}K_{P} (3.1.11)

| Symbol | Name | Description | Type | Source |
|---|---|---|---|---|
| π | Pi | Constant dimensionless factor = | Numeric | Mathematical constant |
| | | 3.1415 | | (given) |
| a | Tank paint solar | Dimensionless empirical factor | Numeric | Reference from Table |
| | absorbence factor | which has been established | | 12.3-7 in AP42 |
| | | through experience. | | reference and based on |
| | | | | color. Stored in |
| | | | | System Library. |
| D | Tank diameter | Cross sectional linear measurement | Numeric | Client data stored in |
| | | of the cylindrical tank. Units = linear | | System Database |
| H_{L} | Liquid Height | Average daily tank gauge reading | Numeric | Client data stored in |
| | | which shows how much is in the | | System Database |
| | | tank. Units = linear (e.g. ft) | | |
| H_{RO} | Roof Outage | Linear measurement of tank roof | Numeric | Client data stored in |
| | | height measured from the vertical | | System Database |
| | | edge of the tank shell to the top of | | |
| | | the dome or coned roof. Units = | | |
| | | linear (l) | | |
| H_{S} | Shell Height | Linear measurement of tank height | Numeric | Client data stored in |
| | | excluding the height of the roof | | System Database |
| | | section of the tank. Units = linear (l) | | |
| H_{VO} | Vapor Space | The height of the inside tank space | Numeric | Result of |
| | Outage | minus the liquid level in linear units, | | Equation 3.1.10 |
| | | e.g. ft | | |
| I | Daily solar | Empirical factor based on tank | Numeric | Referenced from Table |
| | insolation factor | materials and conditions. Units = | | 12.3-6 in AP42 |
| | | BTU/ft³ - day | | reference. Stored in |
| | | | | System Library. |
| K_{E} | Vapor space | Dimensionless empirical factor used | Numeric | Result of Equation |
| | expansion factor | to calculate standing losses in | | 3.1.7 |
| | | Equation (1) | | |
| K_{N} | Turnover factor | Dimensionless empirical factor | Numeric | Taken from FIG. |
| | | | | 12.3-6 in AP42 |
| | | | | reference. Stored in |
| | | | | System Library. |
| K_{P} | Working loss | Dimensionless empirical factor | Numeric | Included by reference. |
| | product factor | which is product specific, i.e. 0.75 | | Stored in System |
| | | for crude oil and 1.0 for all other | | Library. |
| | | organic liquids. | | |
| K_{S} | Vented Vapor | Dimensionless factor used to | Numeric | Result of Equation |
| | Saturation Factor | calculate the Standing Storage | | 3.1.9 |
| | | Losses. | | |
| L_{S} | Standing Losses | Hydrocarbon air emissions from | Numeric | Result of Equation |
| | | crude and condensate above ground | | 3.1.2 |
| | | storage tanks that are given off while | | |
| | | the tank is standing idle (not filling | | |
| | | and emptying) and contains some | | |
| | | quantity of fluid. Measured in lbs/hr, | | |
| | | lbs/day, and tons/year. | | |
| L_{T} | Total losses | Hydrocarbon air emissions from | Numeric | Result of Equation |
| | | crude and condensate above ground | | 3.1.1 |
| | | storage tanks that are a sum of the | | |
| | | working and standing losses as | | |
| | | described above. Measured in lbs/hr, | | |
| | | lbs/day, and tons/year. | | |
| L_{W} | Working Losses | Hydrocarbon air emissions from | Numeric | Result of Equation |
| | | crude and condensate above ground | | 3.1.11 |
| | | storage tanks that are given off | | |
| | | during operations (filling and | | |
| | | emptying) and contains some | | |
| | | quantity of fluid. Measured in lbs/br, | | |
| | | lbs/day, and tons/year. | | |
| Mv | Vapor Molecular | Molecular weight or the weight of an | Numeric | Taken from reference |
| | Weight | Avogadro's number of molecules of | | tables in the AP42 |
| | | the gases in the vapor space volume, | | reference. Stored in |
| | | Units = mass/mole (e.g. lb/lb mole) | | System Library. |
| P_{A} | Atmospheric | Standard ambient atmospheric | Numeric | Constant by reference. |
| | pressure | pressure as measured via barometer, | | Stored in System |
| | | e.g. 14.7 psia | | Library. |
| dP_{B} | Breather vent | The range in pressures at which the | Numeric | Client data stored in |
| | pressure setting | tank vent or hatch will relieve under | | System Database. |
| | range. | the pressure of its contents. | | Otherwise the program |
| | | | | will provide a default |
| | | | | value if the user |
| | | | | chooses. |
| dPv | Daily vapor | The range (or change) in the vapor | Numeric | Derived from FIG. |
| | pressure range | pressure caused by the variance in | | 12.3-1 and Table 12.3- |
| | | maximum and minimum daily | | 6 in AP42 reference. |
| | | ambient temperatures. Provided by | | Stored in System |
| | | reference in pressure measurements. | | Library. |
| P_{VA} | Vapor pressure | True vapor pressure of the liquid at | Numeric | Vapor sample data |
| | | the average liquid surface | | stored in System |
| | | temperature. Units = force/unit area | | Database or table in |
| | | (f/l²) (lbs/inch²) | | AP42 reference stored |
| | | | | in System Library. |
| Q | Annual net | The annual volume of hydrocarbons, | Numeric | Client data stored in |
| | production | e.g. crude oil, that is stored in the | | System Database |
| | through-put | tank being considered. This figure is | | |
| | | taken from actual lease production | | |
| | | volumes. Volumetric units, e.g. bbls | | |
| R | Ideal Gas Constant | Ideal gas constant calculated as | Numeric | Calculated from |
| | | (standard atmospheric pressure - | | constants/Almost |
| | | ideal molar volume of gas/mole - | | always used in USA as |
| | | standard temperature) (e.g. psia - ft³/ | | 10.731. Stored in |
| | | lb-mole - ° R (Rankine) = 10.731) | | System Library. |
| dT_{A} | Daily average | The difference between daily | Numeric | Taken from Table 12.3-6 |
| | temperature range | minimum and maximum | | in AP42 reference. |
| | (° R , ° K) | temperatures taken from Table 12.3- | | Stored in System |
| | | 6 as determined by regional | | Library. |
| | | location. | | |
| T_{AA} | Daily average | Average of daily maximum and | Numeric | Table 12.3 in AP42 |
| | ambient | minimum ambient temperatures. | | reference. Stored in |
| | temperature | Measured in ° R or ° K. | | System Library. |
| T_{B} | Liquid bulk | Liquid bulk temperature at standard | Numeric | Result of Equation |
| | temperature | temp Units = ° R or ° K | | 3.1.6 |
| T_{LA} | Daily average | The average temperature measured | Numeric | Result of Equation |
| | liquid surface | at the surface of the liquid in the | | 3.1.5 |
| | temperature | tank. In this case the temperature is | | |
| | | calculated from ambient | | |
| | | temperatures rather that measured. | | |
| | | Units = ° R (Rankine) | | |
| dTv | Daily vapor | The daily range in temperature of the | Numeric | Result of Equation |
| | temperature range | vapor in the vapor space of the tank | | 3.1.8 |
| | | as described above; calculated. | | |
| Vv | Vapor space | Volumetric calculation of the | Numeric | Result of Equation |
| | volume | average amount of space in the tank | | 3.1.3 |
| | | (overhead) that is not occupied by | | |
| | | liquids. Measurement = 1³ | | |
| Wv | Vapor density | Calculated density of the | Numeric | Result of Equation |
| | | gases(vapors) in the vapor space | | 3.1.4 |
| | | calculated in equation (1)(a) Units = | | |
| | | mass/unit volume (m/l³) (e.g. lb/ft³) | | |

2. Internal Combustion Submodule (3.2)

This submodule calculations emissions from internal combustion engines according to the method set forth in the AP42 Volume I, Stationary Point and Area Sources, Chapter 3, Section 3.2, U.S. Environmental Protection Agency, Office of Air Quality Planning and Standards. The emission factors used in these calculations are either provide by the manufacturer for each particular engine or taken from the AP42 reference.

The primary calculation formula is:

$${\sum }_{i = 1 to n} \frac{{EF}_{i} g}{1 hp hr} \times \frac{Rated {hp}_{i}}{1} \times \frac{24 hrs}{day} \times \frac{365 days}{year} \times \frac{1 lb}{453.6 g} \times \frac{1 ton}{2 , 000 lbs} = \frac{Emissions tons}{year} \qquad \text{(3.2.1)}$$

| Symbol | Name | Description | Type | Source |
|---|---|---|---|---|
| EF | Emission | The amount of an | Numeric | Provided by the |
| | Factor | individual pollutant | | user or obtained |
| | g/hp/hr | that will be | | from the equip- |
| | | generated per horse | | ment data base by |
| | | power hour of | | the id number or |
| | | operation, e.g. | | model of |
| | | 2.0 grams NOx | | compressor |
| | | generated in grams | | |
| | | per hp per hour. | | |
| HP (hp) | Horse | The power rating of | Numeric | Provided by the |
| | power | the compressor in | | user or obtained |
| | rating | horse power per | | from the |
| | | hour | | equipment data |
| | | | | base by the id |
| | | | | number or model |
| | | | | of compressor |

This formula is repeated for each piece of equipment using emissions factors for each of the following pollutants:

| | | | |
|---|---|---|---|
| NOx | Nitrous Oxides | Nitrous oxide | Calculated from AP-42 |
| | | emissions | emission factors or |
| | | | manufacturers data. |
| CO | Carbon | Carbon monoxide | Calculated from AP-42 |
| | Monoxide | emissions | emission factors or |
| | | | manufacturers data. |
| SO₂ | Sulfur dioxide | Sulfur dioxide | Calculated from AP-42 |
| | | emissions | emission factors or |
| | | | manufacturers data. |
| PA or | Particulates | Particulate emission | Calculated from AP-42 |
| PM₁₀ | | from fuel | emission factors or |
| | | combustion | manufacturers data. |
| VOCnm | Non-methane | Measurement of | AP-42 emission |
| | Volatile | emissions of VOC's as | factors or |
| | Organic | tons per year. | manufacturers data. |
| | Compounds | | |

3. External Combustion Submodule (3.3)

This submodule calculations emissions of combustion gases from external combustion units based upon the normal gas consumption and factors for natural gas combustion found in AP-42 (10/92) Section 1.4, Tables 1.4-1 through 1.4-3. Combustion factors for commercial boilers are used in the calculations.

The primary calculation formula is:

$${\sum }_{i = 1 to n} \frac{mm {BTU}_{i}}{hr} \times \frac{1 SCF}{\begin{matrix}Fuel Heat Value \\ in BTU\end{matrix}} \times \frac{EF lbs}{mm SCF} \times \frac{24 hrs}{day} \times \frac{365 days}{year} \times \frac{1 ton}{2 , 000 lbs} = \frac{Emissions tons}{year} \qquad \text{(3.3.1)}$$

| Symbol | Name | Description | Type | Source |
|---|---|---|---|---|
| EF | Emission | Amount of pollutant species | Numeric | Client data |
| | Factor | generated per unit | | stored in |
| | lb/mmscf | of fuel used or burned, e.g. | | System |
| | | lbs (pounds) per mmscf | | Database |
| | | (Million standard cubic | | |
| | | feet) of gas burned. | | |
| mmbtu | BTU | The size of the combustion | Numeric | Client data |
| | rating of | unit as measured in | | stored in |
| | the unit | BTU's per hour. | | System |
| | | mmbtu = million | | Database |
| | | British Thermal Units | | |

This formula is repeated for each piece of equipment using emissions factors for each of the following pollutants:

| | | | |
|---|---|---|---|
| NOx | Nitrous Oxides | Nitrous oxide | Calculated from AP-42 |
| | | emissions | emission factors or |
| | | | manufacturers data. |
| CO | Carbon | Carbon monoxide | Calculated from AP-42 |
| | Monoxide | emissions | emission factors or |
| | | | manufacturers data. |
| SO₂ | Sulfur dioxide | Sulfur dioxide | Calculated from AP-42 |
| | | emissions | emission factors or |
| | | | manufacturers data. |
| PA or | Particulates | Particulate emission | Calculated from AP-42 |
| PM₁₀ | | from fuel | emission factors or |
| | | combustion | manufacturers data. |
| VOCnm | Non-methane | Measurement of | AP-42 emission |
| | Volatile | emissions of VOC's as | factors or |
| | Organic | tons per year. | manufacturers data. |
| | Compounds | | |

4. Fugitive Emissions Submodule (3.4)

Fugitive emission estimates for valves, flanges, piping and compressor seals in natural gas/vapor service are based on emission factors obtained from EPA Document EPA-450/3-83-007. For fugitive emission sources in crude oil service are based on SOCMI fugitive emissions (without ethylene) for components handling light liquids. VOC emissions from components in gas/vapor service are speciated based on gas analyses provided by the user. Emissions from components in crude oil service were not speciated because of the small quantity of emissions generated. Example calculations for fugitive emission estimates are provided below. VOC estimates for fugitive emission sources in all services were derived by the following equation:

The primary calculation formula is:

$${\sum }_{i = 1 to n} \frac{{EF}_{i} lb}{{hr}_{i}} \times \frac{VOC {\%}_{i}}{1} \times \frac{24 hrs}{day} \times \frac{365 days}{year} \times \frac{1 ton}{2 , 000 lbs} = \frac{Emissions tons}{year} \qquad \text{(3.4.1)}$$

This formula is repeated for each fitting in each piece of equipment.

| Symbol | Name | Description | Type | Source |
|---|---|---|---|---|
| EF | Emission | Amount of | Numeric | Provided |
| | Factor | volatile organic | | by reference |
| | | emissions | | from AP42 |
| | | generated per | | and SOCMI. |
| | | fugitive | | |
| | | component | | |
| | | or source. E.G. | | |
| | | lbs/hour/source | | |
| No. of | Number of | Actual number | Numeric | Provided by |
| components, | components | of each | | the user or |
| (src) | | source | | obtained |
| | | component | | from Client |
| | | at the facility | | data stored |
| | | e.g 355 | | in System |
| | | valves, etc. | | Database or |
| | | | | equipment |
| | | | | data stored |
| | | | | in System |
| | | | | Library |
| VOC % | VOC | The | Numeric | Calculated |
| | Concentration | concentration | | from the gas |
| | in the affected | of VOC | | analysis |
| | stream | (volatile | | for this |
| | | organic | | facility. |
| | | hydrocarbon | | |
| | | compounds) | | |
| | | defined as any | | |
| | | compound with | | |
| | | C3+ | | |
| | | hydrocarbons | | |
| | | as identified in | | |
| | | the gas analysis | | |
| | | and as | | |
| | | calculated | | |
| | | by volume %. | | |

5. Glycol Dehydration Submodule (3.5)

Emissions for the glycol dehydration units were calculated using the GRI-GLYCALC model. All input variables are taken as provided by the client and are as follows:

| Symbol | Name | Description | Type | Source |
|---|---|---|---|---|
| | Unit | Case name and case description used | Text | Provided by the user or |
| | Description | to retrieve case files from the GRI | | taken from the facility data |
| | | program. This name will also | | base as a facility name. |
| | | be identified by a facility ID number | | |
| | | and an equipment ID number. | | |
| | Annual Hours | Number of hours the unit operates | Numeric | Input by user or user data |
| | of Operation | annually, e.g 8760 hrs = 1 year | | base. |
| | Gas | Percentages of all components in the | Numeric | Gas analysis provided by |
| | Composition | gas stream. Individual values input | and text | user or from Client data |
| | | separately from gas analysis. | | stored in System Database |
| mmscf/ | Dry gas flow | The volumetric flow of the sales gas | Numeric | Production data from user |
| day | rate | stream in volumetric units per day (e.g. | | or Client data stored in |
| | | mmscf/day or million standard cubic | | System Database |
| | | feet per day) | | |
| lb/ | Dry gas water | The target final concentration of water | Numeric | Client data stored in |
| mmwscf | content | in the sales gas stream, in the USA the | | System Database or |
| | | default value is 7.0 lb/mmscf | | accepted by default |
| | Absorber | Number of actual equilibrium stages in | Numeric | Chosen by user |
| | stages | the contactor; may be chosen, if | | |
| | | known, by the user as an alternative | | |
| | | entry to the dry gas water content | | |
| | | described above. | | |
| | Lean TEG/ | The pumping rate of the lean or fresh | Numeric | Client data stored in |
| | EG flow rate | tri-ethylene glycol (or ethylene glycol) | | System Database |
| | | solution in gallons per minute | | |
| | Water content | The allowable water concentration in | Numeric | Client data stored in |
| | | the lean or fresh glycol stream. A | | System Database of |
| | | default value of 1.5% may be chosen if | | chosen by default |
| | | the use does not have this value | | |
| | Re-circulation | The gallons of glycol solution | Numeric | Client data stored in |
| | ratio | circulated per pound of water removed | | System Database |
| | | from the wet gas stream if known. | | |
| | | May be chosen in place of the lean | | |
| | | TEG/EG flow rate. Default value of | | |
| | | 0.3 may be chosen in the program. | | |
| | Wet Gas | Temperature of the incoming wet gas | Numeric | Client data stored in |
| | Temperature | stream in ° F. | | System Database |
| | Wet gas | Pressure of the incoming wet gas | Numeric | Client data stored in |
| | pressure | stream in psig. | | System Database |
| | Glycol pump | May be gas driven or electric | Text | Client data stored in |
| | type | | | System Database |
| ACFM/ | Gas drive | ACFM (air cubic feet per minure) gas/ | Numeric | Client data stored in |
| gal | pump volume | gallon per minute glycol pumped (only | | System Database |
| | ratio | for gas driven pumps) May choose | | |
| | | default values of 0.03 for wet gas | | |
| | | pressures greated than 40 psig and 0.08 | | |
| | | for units with wet gas pressures less | | |
| | | than 400 psig. | | |
| | Flash Tank | Yes or no question. Is a flash tank | Text | Client data stored in |
| | | involved with this unit. | | System Database |
| | Flash tank | Operating temperature of the flash tank | Numeric | Client data stored in |
| | temperature | if used in ° Fahrenheit (° F.) | | System Database |
| PSIG | Flash tank | Operating pressure of the flash tank if | Numeric | Client data stored in |
| | pressure | used. Psig (pounds per square inch | | System Database |
| | | gauge) | | |
| | Stripping gas | Yes or no question. Is a gas stream | Text | Client data stored in |
| | option | used to remove the hydrocarbons from | | System Database |
| | | the glycol vent stream? | | |
| | Stripping gas | Flow rate of the stripping gas stream, | Numeric | Client data stored in |
| | flow rate | scfm | | System Database |
| | Control device | Choose a control device as either a | Text | Client data stored in |
| | option | vent condenser or vapor incinerator, or | | System Database |
| | | choose no control device. | | |
| | Vent | Operating temperature of the vent | Numeric | Client data stored in |
| | condenser | condenser (if used) in ° F. | | System Database |
| | temperature | | | |
| | Vent | Operating pressure of the vent | Numeric | Client data stored in |
| | condenser | condenser (if used) in absolute | | System Database |
| | pressure | pressure, e.g. psia | | |
| | Incinerator | Average ambient air temperature for | Numeric | Selected from climatic |
| | ambient air | the location in ° F. | | data stored in System |
| | temperature | | | Library |
| | Excess oxygen | % excess oxygen used in combustion | Numeric | Provided by the |
| | | process if a vapor incinerator is chosen | | manufacturer of the |
| | | as a control device. | | combustion unit and |
| | | | | included in the System |
| | | | | Library |
| | Comubstion | % efficiency of the vapor control | Numeric | Provided by the |
| | efficiency | incinerator unit. | | manufacturer of the |
| | | | | combustion unit and |
| | | | | included in the equipment |
| | | | | data base. |
| VOCs | Volatile | Measurement of emissions of VOC's | Numeric | Glycalc ® program output |
| | Organic | as tons per year from the Glycalc | | |
| | Compounds | Program Printout in tons/year | | |
| HAPs | Hazardous Air | Volumetric measurement of a group of | Numeric | Glycalc ® program output |
| | Pollutants | air constituents that have been | | of information gained from |
| | | determind by the Environmental | | the EPA speciation |
| | | Protection Agency (EPA) to be | | program for HAP's. |
| | | considered categorically hazardous to | | |
| | | health and the human environment. | | |
| | | Measured in tons/year | | |

Two separate calculations are used to calculate the flash emissions caused by the transfer of higher pressure liquids from a process vessel to a storage tank of less pressure. These are the Black Oil GOR (gas oil ratio) method developed by Rollins, McCain and Creeger,

log Rₛₜ=0.4896−4.916logγₒₛₜ+3.496logγₛₚ+1.501logPₛₚ−0.9213logTₛₚ (3.6.1)

and the Vasquez Beggs GOR Correlation.

$$\begin{matrix}GOR = C1 \times SG100 \times {( {P}_{str} + {P}_{atm} )}^{C2} \times {e}^{\frac{C3 \times °API}{{T}_{gas} °F . + 460}} & \text{(3.6.2)} \\ SG100 = SG \times ( 1.0 + 5.912 \times {10}^{- 5} \times {T}_{gas} °F \times log \frac{{P}_{sep} + {P}_{atm}}{114.7} & \text{(3.6.3)}\end{matrix}$$

| Symbol | Name | Description | Type | Source |
|---|---|---|---|---|
| Rₛₜ | Stock Tank Gas Oil | The ratio of the volume of gas | Numeric | Calculated by Black |
| | Ratio (GOR) | generated per barrel of oil produced as | | Oil GOR equation, |
| | | a result of the pressure drop between | | 3.6.1 |
| | | the pressurized separator and the oil | | |
| | | storage (stock) tank. Units = volume | | |
| | | gas/volume oil, e.g standard cubic | | |
| | | feet/barrel | | |
| γₒₛₜ | Stock Tank Oil | Measurement of the ratio of the weight | Numeric | Calculated using the |
| | specific gravity | of the oil relative to water at standard | | physical data of the |
| | | temperature and pressure. E.g. units = | | materials being |
| | | lb/gal per lb/gal or SG = 6.5 lb/gal oil/ | | stored |
| | | 8.34 lb/gal water @ STP = 0.78 | | |
| γₛₚ | Separator specific | Measurement of the ratio of the weight | Numeric | Calculated using the |
| | gravity | of the air relative to | | physical data of the |
| | | | | gas being measured |
| Pₛₚ | Separator pressure | The operating pressure of the vessel | Numeric | Measured at the |
| | | used to separate the oil, water and gas | | equipment by the |
| | | in the produced fluid stream | | user |
| Tₛₚ | Separator | The operating temperature of the | Numeric | Provided by the |
| | temperature | separator measured in ° F. | | user from field |
| | | | | measurements |
| V_{MW} | Vapor Molecular | The weight of one mole (or | Numeric | Determined by |
| | Weight | Avogadro's number of molecules) of | | reference or |
| | | the gas being measured. | | measurement. May |
| | | | | use default value or |
| | | | | actual gas analysis. |
| C1, C2, | Vasquez Beggs | Constants calculated for the use in this | Numeric | Provided by |
| C3 | Constants | relationship using statistical empirical | | reference to the |
| | | data. Dimensionless | | relationship based |
| | | | | on degree API |
| | | | | gravity range of the |
| | | | | crude being stored. |
| SG | Specific Gravity of | Same as γₛₚ or separator specific | Numeric | Calculated using the |
| | the gas | gravity as described above. | | physical data of the |
| | | | | gas being measured |
| SG100 | Specific gravity of | A calculated quantity based on the | Numeric | Result of equation |
| | the gas referenced | temperature and pressure measured at | | 3.63 |
| | to 100 psig | the separator referenced to 100 pounds | | |
| | | per square inch gauge (psig) pressure. | | |
| Pₛₜᵣ | Pressure of the | Pressure of the fluid stream as it leaves | Numeric | Measured in the |
| | upstream fluid | the separator or the separator pressure. | | field by the user. |
| Pₐₜₘ | Atmospheric | The measured pressure of ambient | Numeric | Measured at the |
| | pressure | conditions or in the atmosphere outside | | field location using |
| | | the separator. | | a barometer or by |
| | | | | default at ST&P. |
| T_{gas} | Gas temperature at | The measured temperature of the gas | Numeric | Measured at the |
| | the separator | stream in the separator | | field location by the |
| | | | | user. |
| Pₛₑₚ | Separator Pressure | The operating pressure of the separator | Numeric | Measured at the |
| | | measured in psig | | field location by the |
| | | | | user. |
| psig | Pounds per square | Pressure measurement in units of | Numeric | Measured with a |
| | inch gauge | pounds per square inch or in general | | pressure measuring |
| | | units - f/l². | | device at the |
| | | | | equipment site. |
| ° API | Degrees API gravity | The meaured API gravity of the fluid | Numeric | Calculated using the |
| | | (crude) being measured as calculated | | physical data of the |
| | | by a standard equation which ratios the | | fluid. |
| | | specific gravity of the fluid to a | | |
| | | referenced standard. | | |
| ° F. | Degrees Fahrenheit | The standard temperature measurement | Numeric | Standard unit |
| | | using degrees Fahrenheit as a scale. | | |
| log | Logarithm | Mathematical relationship which | Text | Standard unit |
| | | equals the exponent value that the | | |
| | | number 10 would be raised to get that | | |
| | | same number. | | |

7. Loading Losses Submodule (3.7)

Loading losses are the primary source of emissions from rail tank car, tank car, and marine vessel operations. Loading losses occur as organic vapors in “empty” cargo tanks are displaced to the atmosphere by the liquid being loaded into the tanks. These vapors are a composite of vapors formed in the empty tank by evaporation of residual product from the previous load, vapors transferred to the tank in vapor balance systems as product is being unloaded, and vapors generated in the tank as the new product is being loaded. Loading losses is calculated according to the procedures outlined in Section 5.2 of the EPA DOCUMENT AP-42, COMPILATION OF AIR POLLUTANT EMISSION FACTORS, VOLUME I, STATIONARY POINT AND AREA SOURCES, CHAPTER 5, SECTION 5.2 DATED JANUARY 1995. The quantity of evaporative losses from loading operations is a function of the following parameters:

Physical and chemical characteristics of the previous cargo;

Method of unloading the previous cargo;

Operations to transport the empty carrier to a loading terminal;

Method of loading the new cargo; and

Physical and chemical characteristics of the new cargo.

Emissions from loading petroleum liquid can be estimated (with a probable error of 30%) using the following equation:

$${L}_{L} = 12.46 \frac{SPM}{T} \qquad \text{(3.7.1)}$$

| Symbol | Name | Description | Type | Source |
|---|---|---|---|---|
| L_{L} | Loading | The Volatile | Numeric | Result of |
| | losses - | Organic | | equation 3.7.1 |
| | VOC | Compound | | |
| | | (VOC) | | |
| | | emissions | | |
| | | quantity as | | |
| | | determined in | | |
| | | the above | | |
| | | equation. | | |
| S | Saturation | Empirical quantity | Numeric | AP-42 |
| | factor | for calculation | | reference Table |
| | | | | 5.2-1. Stored in |
| | | | | System |
| | | | | Library. |
| P | True | The true vapor | Numeric | By reference |
| | liquid | pressure of the liquid | | from AP-42 |
| | vapor | being loaded which | | FIGS. 7.1-5, |
| | pressure | is the pressure at | | 7.1-6, 7.1-2. |
| | of the | which the liquid is in | | Stored in |
| | liquid | equilibrium with the | | System |
| | being | overhead vapors. | | Library. |
| | loaded | Measured in pounds | | |
| | | per square inch | | |
| | | atmospheric (psia) | | |
| M | Vapor | The weight per | Numeric | By reference |
| | Molecular | mole of gases being | | from AP-42 |
| | Weight | emitted, e.g lb/lb | | Table 7.1-2. |
| | | mole. One mole = | | Stored in |
| | | weight of 10²³ | | System |
| | | molecules (Avogadro's | | Library. |
| | | number) | | |
| | | of the gas or 359 | | |
| | | standard cubic feet. | | |
| | | (SCF) | | |
| T | Bulk | The temperature of the | Numeric | Supplied from |
| | Liquid | liquid being loaded | | the tank |
| | Tempera- | in ° R (Rankine) = | | calculation |
| | ture | ° F. + 460. | | data. |

8. Hazardous Air Pollutants submodule (3.8)

Hazardous Air Pollutants (HAPs) have been defined by the EPA to include the following compounds which are common to oil and gas production emissions:

Hexane

Xylene

Benzene

Xylene

Toluene

Ethylbenzene

Formaldehyde

Acetaldehyde

These component concentrations will be retrieved by using calculation routines that speciate the VOC emissions into the above compounds. Calculation routines such as this are produced in software form by both the Gas Research Institute and the Environmental Protection Agency. The user will need to only supply the equipment or application type and the VOC emissions for that particular unit and the program will speciate the HAP emissions form that stream by concentration and report them as such. The output for this module will be the HAP emissions in tons per year and lbs per day.

9. Emissions Inventory Submodule (3.20)

The air emissions inventory is a summary of all of the air emissions generated by the various unit sources at a facility. This inventory is a time based report that catalogues these emission volumes on an annual basis for reporting to the state air pollution control agencies. Each report must present:

1) The individual calculations for each unit source in the facility, which includes every piece of equipment or process that has the potential to produce air emissions of regulated constituents, e.g. nitrous oxides (NOx), carbon monoxide (CO), particulates (PA or PM₁₀), sulfur dioxide (SO₂), volatile organic compounds (VOCs), hazardous air pollutants (HAPs), etc.

2) The sources of the data used in the calculations, i.e. measured data, estimated data, calculated data, industry or government standard data (AP42), etc., along with any assumptions associated with this data.

3) The summary of the emissions of the individual constituents reported by unit source and by facility.

4) The status of the equipment, e.g. active, idle, shut down, moved, etc.

5) All emissions factors used to calculate the emissions in the summary.

6) The operating schedule of each source or the amount of time (days, hours, etc.) that the individual sources were on line and operating (i.e. generating emissions) during the year.

7) The equipment parameters, i.e. stack height, stack diameter, power ratings (hp, btu, etc.), fuel usage, fuel type.

10. Air Permitting submodule (3.21)

The air permitting data group will require much the same data as the emissions inventory group will, with much additional text type data required. In addition to the data listed in the table for each type facility and equipment, this group will include:

A) Company mailing and personnel information, e.g who will be the responsible party for signature authority on the permit, who will have regulatory responsibility over the compliance issues, and who will be responsible for operational oversight at this facility.

B) The legal location of the facility, e.g latitude/longitude, section-township-range, utm coordinates, etc., including county, state and nearest town or city.

C) The compliance codes for each unit at the facility, if a Title V Federal Operating Permit is being sought.

The permit will also required the same seven sets of information described above for submodule 3.21.

11. Emissions Fees Submodule (3.22)

The emissions fees submodule will take the summary emissions figures from the annual emissions inventory report and generate a figure for the fee based on these annual emissions. The sum total of these emissions will be multiplied by the price per ton per year for emissions fees that are established for that particular state. The user will be required to provide support for these figures in the form of sample calculations and equipment data verification sheets.

The primary calculation formula is:

$$\sum Emissions \frac{tons}{year} \times \$ per ton = Annual Emissions Fee \qquad \text{(3.22.1)}$$

| Symbol | Name | Description | Type | Source |
|---|---|---|---|---|
| $ | Price per ton | The dollar price per | Numeric | Established |
| | | tons of emissions as | | by law |
| | | established by the | | |
| | | particular state of | | |
| | | operation | | |
| NOx | Nitrous | Nitrous oxide | Numeric | Calculated |
| | Oxides | emissions | | |
| CO | Carbon | Carbon monoxide | Numeric | Calculated |
| | Monoxide | emissions | | |
| SO₂ | Sulfur | Sulfur dioxide | Numeric | Calculated |
| | dioxide | emissions | | |
| PA | Particulates | Particulate emission | Numeric | Calculated |
| or PM₁₀ | | from fuel combustion | | |
| VOCs | Volatile | VOC emissions | Numeric | Calculated |
| | Organic | | | |
| | Compounds | | | |

From the foregoing description of the preferred embodiment it will be readily understood that the subject invention provides a method for collecting, assimilating and storing data in a searchable database for providing automated on-line compliance with regulatory requirements of various agencies. While certain embodiments and features have been described in detail herein, it should be understood that the invention includes all modifications and enhancements within the scope and spirit of the following claims.

What is claimed is:

1. A method for collecting, assimilating and utilizing data from a variety of sources for determining the regulatory requirements and for generating the related compliance reports for an industry, the method comprising the steps of:
a. collecting external data required for compliance requirements of a compliance model;
b. collecting data from a user;
c. assimilating the external data and the user data in a processor to determine compliance by the user;
d. automatically generating a report unique to the user data containing required compliance information.

2. The method of claim 1, wherein the external data is public data.

3. The method of claim 1, wherein the compliance model is a government agency compliance requirement.

4. The method of claim 1, further including the step of electronically submitting the generated report to a relevant agency.

5. The method of claim 1, wherein the collected public data is industry specific.

6. The method of claim 1, wherein the collected user data is facility specific.

7. The method of claim 6, wherein the collected user data is equipment specific.

8. The method of claim 6, wherein the collected user data is location specific.

9. The method of claim 1, further including the step of creating a library of available data from the collected public data and non-confidential portions of the collected user data.

10. The method of claim 1, further including the steps of linking the public data to on-line databases and importing data from said databases into the collected public data.

11. The method of claim 1, wherein there is further included a mathematical database and wherein data in the collected public data and in the collected user data is imported into the mathematical database for calculating compliance data in the generation of a report.

12. The method of claim 11, wherein the mathematical database is an air module database for calculating hydrocarbon emissions from a crude oil storage tank.

13. The method of claim 12, wherein the mathematical database includes the following primary calculation formulas for calculating hydrocarbon emissions from storage tanks:
$$\begin{matrix}{L}_{T} = {L}_{S} + {L}_{W} \\ {L}_{S} = 365 {V}_{V} {W}_{V} {K}_{E} {K}_{S} \\ {V}_{V} = \frac{π}{4} {D}^{2} ( {H}_{S} - {H}_{L} + {H}_{RO} ) \\ {W}_{V} = \frac{{M}_{V} {P}_{VA}}{{RT}_{LA}} \\ {T}_{LA} = .044 {T}_{AA} + 0.56 {T}_{B} + 0.0079 aI \\ {T}_{B} = {T}_{AA} + 6 a - 1 \\ {K}_{E} = \frac{{dT}_{V}}{{T}_{LA}} + \frac{{dP}_{V} - {dP}_{B}}{{P}_{A} - {P}_{VA}} \\ {dT}_{V} = .072 {dT}_{A} + 0.028 I \\ {K}_{S} = \frac{1}{1 + 0.053 {P}_{VA} {H}_{VO}} \\ {H}_{VO} = {H}_{S} - {H}_{L} + {H}_{RO} \\ {L}_{W} = 0.0010 {M}_{V} {P}_{VA} {QK}_{N} {K}_{P}\end{matrix}$$

| Symbol | Name | Description | Type | Source |
|---|---|---|---|---|
| π | Pi | Constant dimensionless | Numeric | Mathematical constant |
| | | factor = 3.1415 | | (given) |
| a | Tank paint | Dimensionless empirical | Numeric | Reference from Table |
| | solar absorb- | factor which has been | | 12.3-7 in AP42 |
| | ence factor | established through | | reference and based on |
| | | experience. | | color. Stored in |
| | | | | System Library. |
| D | Tank diameter | Cross sectional linear | Numeric | Client data stored in |
| | | measurement of the | | System Database |
| | | cylindrical tank. | | |
| | | Units = linear | | |
| H_{L} | Liquid Height | Average daily tank | Numeric | Client data stored in |
| | | gauge reading which | | System Database |
| | | shows how much is in the | | |
| | | tank. Units = linear | | |
| | | (e.g. ft) | | |
| H_{RO} | Roof Outage | Linear measurement | Numeric | Client data stored in |
| | | of tank roof height | | System Database |
| | | measured from the vertical | | |
| | | edge of the tank shell | | |
| | | to the top of the dome | | |
| | | or coned roof. Units = | | |
| | | linear (1) | | |
| H_{S} | Shell Height | Linear measurement of | Numeric | Client data stored in |
| | | tank height excluding | | System Database |
| | | the height of the roof | | |
| | | section of the tank. | | |
| | | Units = linear (1) | | |
| H_{VO} | Vapor Space | The height of the | Numeric | Result of Equation |
| | Outage | inside tank space | | 3.1.10 |
| | | minus the liquid | | |
| | | level in linear units, | | |
| | | e.g. ft | | |
| I | Daily solar | Empirical factor based | Numeric | Referenced from Table |
| | insolation | on tank materials and | | 12.3-6 in AP42 |
| | factor | conditions. Units = | | reference. Stored in |
| | | BTU/ft³-day | | System Library. |
| K_{E} | Vapor space | Dimensionless empirical | Numeric | Result of Equation |
| | expansion | factor used to calculate | | 3.1.7 |
| | factor | standing losses in | | |
| | | Equation (1) | | |
| K_{N} | Turnover | Dimensionless empirical | Numeric | Taken from Figure |
| | factor | factor | | 12.3-6 in AP42 |
| | | | | reference. Stored in |
| | | | | System Library. |
| K_{P} | Working | Dimensionless empirical | Numeric | Included by reference. |
| | loss | factor which is product | | Stored in System |
| | product | specific, i.e. 0.75 for | | Library. |
| | factor | crude oil and 1.0 for | | |
| | | all other organic liquids. | | |
| K_{S} | Vented Vapor | Dimensionless factor | Numeric | Result of Equation |
| | Saturation | used to calculate | | 3.1.9 |
| | Factor | the Standing Storage | | |
| | | Losses. | | |
| L_{S} | Standing | Hydrocarbon air emis- | Numeric | Result of Equation |
| | Losses | sions from crude and | | 3.1.2 |
| | | condensate above ground | | |
| | | storage tanks that are | | |
| | | given off while the tank | | |
| | | is standing idle (not | | |
| | | filling and emptying) | | |
| | | and contains some quantity | | |
| | | of fluid. Measured in lbs/hr, | | |
| | | lbs/day, and tons/year. | | |
| L_{T} | Total | Hydrocarbon air emissions | Numeric | Result of Equation |
| | losses | from crude and condensate | | 3.1.1 |
| | | above ground storage tanks | | |
| | | that are a sum of the | | |
| | | working and standing losses | | |
| | | as described above. Measured | | |
| | | in lbs/hr, lbs/day, and tons/year. | | |
| L_{W} | Working | Hydrocarbon air emissions from | Numeric | Result of Equation |
| | Losses | crude and condensate above | | 3.1.11 |
| | | ground storage tanks that | | |
| | | are given off during oper- | | |
| | | ations (filling and emptying) | | |
| | | and contains some quantity | | |
| | | of fluid. Measured in lbs/hr, | | |
| | | lbs/day, and tons/year. | | |
| Mv | Vapor | Molecular weight or the | Numeric | Taken from reference |
| | Molecular | weight of an Avogadro's | | tables in the AP42 |
| | Weight | number of molecules of | | reference. Stored in |
| | | the gases in the vapor | | System Library. |
| | | space volume. Units = | | |
| | | mass/mole (e.g. lb/lb | | |
| | | mole) | | |
| P_{A} | Atmospheric | Standard ambient atmos- | Numeric | Constant by reference. |
| | pressure | pheric pressure as | | Stored in System |
| | | measured via barometer, | | Library. |
| | | e.g. 14.7 psia | | |
| dP_{B} | Breather | The range in pressures | Numeric | Client data stored in |
| | vent | tank vent or hatch will | | System Database. |
| | pressure | relieve under the | | Otherwise the program |
| | setting | pressure of its contents. | | will provide a default |
| | range. | | | value if the user |
| | | | | chooses. |
| dPv | Daily | The range (or change) | Numeric | Derived from FIG. |
| | vapor | in the vapor pressure | | 12.3-1 and Table |
| | pressure | caused by the variance in | | 12.3-6 in AP42 |
| | range | maximum and minimum daily | | reference. Stored |
| | | ambient temperatures. | | in System Library. |
| | | Provided by reference | | |
| | | in pressure measurements. | | |
| P_{VA} | Vapor | True vapor pressure of | Numeric | Vapor sample data |
| | pressure | the liquid at the aver- | | stored in System |
| | | age liquid surface temper- | | Database or table in |
| | | ature. Units = force/ | | AP42 reference stored |
| | | unit area (f/l²) | | in System Library. |
| | | (lbs/inch²) | | |
| Q | Annual net | The annual volume of hydrocarbons, | Numeric | Client data stored in |
| | production | e.g. crude oil, that is stored in the | | System Database |
| | through-put | tank being considered. This figure is | | |
| | | taken from actual lease production | | |
| | | volumes. Volumetric units, e.g. bbls | | |
| R | Ideal Gas | Ideal gas constant calculated as | Numeric | Calculated from |
| | Constant | (standard atmospheric pressure- | | constants/Almost |
| | | ideal molar volume of gas/mole- | | always used in USA as |
| | | standard temperature) (e.g. psia- | | 10.731. Stored in |
| | | ft³/lb-mole-° R | | System Library. |
| | | (Rankine) = 10.731) | | |
| dT_{A} | Daily average | The difference between daily | Numeric | Taken from Table 12.3- |
| | temperature | minimum and maximum | | 6 in AP42 reference. |
| | range | temperatures taken from Table 12.3- | | Stored in System |
| | (° R ,° K) | 6 as determined by regional | | Library. |
| | | location. | | |
| T_{AA} | Daily average | Average of daily maximum and | Numeric | Table 12.3 in AP42 |
| | ambient | minimum ambient temperatures. | | reference. Stored in |
| | temperature | Measured in ° R or ° K. | | System Library. |
| T_{B} | Liquid bulk | Liquid bulk temperature at standard | Numeric | Result of Equation |
| | temperature | temp Units = ° R or ° K | | 3.1.6 |
| T_{LA} | Daily average | The average temperature measured | Numeric | Result of Equation |
| | liquid surface | at the surface of the liquid in the | | 3.1.5 |
| | temperature | tank. In this case the temperature is | | |
| | | calculated from ambient | | |
| | | temperatures rather that measured. | | |
| | | Units = ° R (Rankine) | | |
| dTv | Daily vapor | The daily range in temperature of the | Numeric | Result of Equation |
| | temperature | vapor in the vapor space of the tank | | 3.1.8 |
| | range | as described above; calculated. | | |
| Vv | Vapor space | Volumetric calculation of the | Numeric | Result of Equation |
| | volume | average amount of space in the tank | | 3.1.3 |
| | | (overhead) that is not occupied by | | |
| | | liquids. Measurement = l³ | | |
| Wv | Vapor density | Calculated density of the | Numeric | Result of Equation |
| | | gases(vapors) in the vapor space | | 3.1.4 |
| | | calculated in equation (1)(a) Units = | | |
| | | mass/unit volume (m/l³) (e.g. lb/ft³) | | |

14. The method of claim 12, wherein the mathematical database includes the following primary calculation formulas for calculating hydrocarbon emissions from internal combustion engines:
$${\sum }_{i = 1 to n} \frac{{EF}_{i} g}{1 hp hr} \times \frac{Rated {hp}_{i}}{1} \times \frac{24 hrs}{day} \times \frac{365 days}{year} \times \frac{1 lb}{453.6 g} \times \frac{1 ton}{2 , 000 lbs} = \frac{Emissions tons}{year}$$

| Symbol | Name | Description | Type | Source |
|---|---|---|---|---|
| EF | Emission | The amount of an individual | Numeric | Provided by the user or |
| | Factor | pollutant that will be | | obtained from the |
| | g/hp/hr | generated per horse power | | equipment data base by |
| | | hour of operation, e.g. | | the id number or model |
| | | 2.0 grams NOx generated | | of compressor |
| | | in grams per hp per hour. | | |
| HP (hp) | Horse power | The power rating of the | Numeric | Provided by the user or |
| | rating | compressor in horse | | obtained from the |
| | | power per hour | | equipment data base by |
| | | | | the id number or model |
| | | | | of compressor |

15. The method of claim 14, whereing the primary formula is repeated for each of the following pollutants:

| | | | |
|---|---|---|---|
| NOx | Nitrous | Nitrous oxide emissions | Calculated from AP-42 emission factors or |
| | Oxides | | manufacturers data. |
| CO | Carbon | Carbon monoxide | Calculated from AP-42 emission factors or |
| | Monoxide | emissions | manufacturers data. |
| SO₂ | Sulfur | Sulfur dioxide emissions | Calculated from AP-42 emission factors or |
| | dioxide | | manufacturers data. |
| PA or | Particulates | Particulate emission from | Calculated from AP-42 emission factors or |
| PM₁₀ | | fuel combustion | manufacturers data. |
| VOCnm | Non-methane | Measurement of emissions | AP-42 emission factors or manufacturers data. |
| | Volatile | of VOC's as tons per year. | |
| | Organic | | |
| | Compounds | | |

16. The method of claim 12, wherein the mathematical database includes the following primary calculation formulas for calculating hydrocarbon emissions from external combustion units:
$${\sum }_{i = 1 to n} \frac{mm {BTU}_{i}}{hr} \times \frac{1 SCF}{\begin{matrix}Fuel Heat Value \\ in BTU\end{matrix}} \times \frac{EF lbs}{mm SCF} \times \frac{24 hrs}{day} \times \frac{365 days}{year} \times \frac{1 ton}{2 , 000 lbs} = \frac{Emissions tons}{year}$$

| Symbol | Name | Description | Type | Source |
|---|---|---|---|---|
| EF | Emission Factor | Amount of pollutant species | Numeric | Client data stored in |
| | lb/mmscf | generated per unit of fuel used or | | System Database |
| | | burned, e.g. lbs (pounds) per mmscf | | |
| | | (Million standard cubic feet) of gas | | |
| | | burned. | | |
| mmbtu | BTU rating of | The size of the combustion unit as | Numeric | Client data stored in |
| | the unit | measured in BTU's per hour. | | System Database |
| | | mmbtu = million British Thermal | | |
| | | Units | | |

17. The method of claim 16, wherein the primary formula is repeated for each of the following pollutants:

| | | | |
|---|---|---|---|
| NOx | Nitrous | Nitrous oxide emissions | Calculated from AP-42 emission factors or |
| | Oxides | | manufacturers data. |
| CO | Carbon | Carbon monoxide | Calculated from AP-42 emission factors or |
| | Monoxide | emissions | manufacturers data. |
| SO₂ | Sulfur | Sulfur dioxide emissions | Calculated from AP-42 emission factors or |
| | dioxide | | manufacturers data. |
| PA or | Particulates | Particulate emission from | Calculated from AP-42 emission factors or |
| PM₁₀ | | fuel combustion | manufacturers data. |
| VOCnm | Non-methane | Measurement of emissions | AP-42 emission factors or manufacturers data. |
| | Volatile | of VOC's as tons per year. | |
| | Organic | | |
| | Compounds | | |

18. The method of claim 12, wherein the mathematical database includes the following primary calculation formulas for calculating emissions for valves, flanges piping and compressor seals:
$${\sum }_{i = 1 to n} \frac{{EF}_{i} lb}{{hr}_{i}} \times \frac{VOC {\%}_{i}}{1} \times \frac{24 hrs}{day} \times \frac{365 days}{year} \times \frac{1 ton}{2 , 000 lbs} = \frac{Emissions tons}{year} .$$

19. The method of claim 18, wherein the primary formula is repeated for each fitting in each piece of equipment:

| Symbol | Name | Description | Type | Source |
|---|---|---|---|---|
| EF | Emission Factor | Amount of volatiole organic emissions | Numeric | Provided by |
| | | generated per fugitive component or | | reference from |
| | | source. E.G..bs/hour/source | | AP42 and |
| | | | | SOCMI. |
| No. of | Number of | Actual number of each source | Numeric | Provided by the |
| components, | components | component at the facility, e.g 355 | | user or obtained |
| (src) | | valves, etc. | | from Client data |
| | | | | stored in System |
| | | | | Database or |
| | | | | equipment data |
| | | | | stored in System |
| | | | | Library |
| VOC% | VOC Concentration | The concentration of VOC (volatile | Numeric | Calculated from |
| | in the affected | organic hydrocarbon compounds) | | the gas analysis |
| | stream | defined as any compound with C3+ | | for this facility. |
| | | hydrocarbons as identified in the gas | | |
| | | analysis and as calculated by volume | | |
| | | %. | | |

20. The method of claim 18, wherein the mathematical database includes the primary calculation formula for calculating emissions for glycol dehydration units, wherein:

| Symbol | Name | Description | Type | Source |
|---|---|---|---|---|
| | Unit | Case name and case description | Text | Provided by the user or |
| | Description | used to retrieve case files from | | taken from the facility data |
| | | the GRI program. This name will also | | base as a facility name. |
| | | be identified by a facility ID number | | |
| | | and an equipment ID number. | | |
| | Annual Hours | Number of hours the unit operates | Numeric | Input by user or user data |
| | of Operation | annually, e.g 8760 hrs = 1 year | | base. |
| | Gas | Percentages of all components in the | Numeric | Gas analysis provided by |
| | Composition | gas stream. Individual values input | and text | user or from Client data |
| | | separately from gas analysis. | | stored in System Database |
| mmscf/ | Dry gas flow | The volumetric flow of the sales gas | Numeric | Production data from user |
| day | rate | stream in volumetric units per day (e.g. | | or Client data stored in |
| | | mmscf/day or million standard cubic | | System Database |
| | | feet per day) | | |
| lb/ | Dry gas water | The target final concentration of water | Numeric | Client data stored in |
| mmwscf | content | in the sales gas stream, in the USA the | | System Database or |
| | | default value is 7.0 lb/mmscf | | accepted by default |
| | Absorber | Number of actual equilibrium stages in | Numeric | Chosen by user |
| | stages | the contactor; may be chosen, if | | |
| | | known, by the user as an altemative | | |
| | | entry to the dry gas water content | | |
| | | described above. | | |
| | Lean TEG/ | The pumping rate of the | Numeric | Client data stored in |
| | EG flow rate | lean or fresh tri-ethylene | | System Database |
| | | glycol (or ethylene glycol) | | |
| | | solution in gallons per minute | | |
| | Water content | The allowable water concentra- | Numeric | Client data stored in |
| | | tion in the lean or fresh glycol | | System Database or |
| | | stream. A default value of 1.5% | | chosen by default |
| | | may be chosen if the user does | | |
| | | not have this value | | |
| | Re-circulation | The gallons of glycol solution | Numeric | Client data stored in |
| | ratio | circulated per pound of water | | System Database |
| | | removed from the wet gas stream | | |
| | | if known. May be chosen in place | | |
| | | of the lean TEG/EG flow rate. | | |
| | | Default value of 0.3 may be | | |
| | | chosen in the program. | | |
| | Wet Gas | Temperature of the incoming | Numeric | Client data stored in |
| | Temperature | wet gas stream in ° F. | | System Database |
| | Wet gas | Pressure of the incoming wet gas | Numeric | Client data stored in |
| | pressure | stream in psig. | | System Database |
| | Glycol pump | May be gas driven or electric | Text | Client data stored in |
| | type | | | System Database |
| ACFM/ | Gas driven | ACFM (air cubic feet per minute) gas/ | Numeric | Client data stored in |
| gal | pump volume | gallon per minute glycol pumped (only | | System Database |
| | ratio | for gas driven pumps) May choose | | |
| | | default values of 0.03 for wet gas | | |
| | | pressures greater than 40 psig and 0.08 | | |
| | | for units with wet gas pressures less | | |
| | | than 400 psig. | | |
| | Flash Tank | Yes or no question. Is a flash tank | Text | Client data stored in |
| | | involved with this unit. | | System Database |
| | Flash tank | Operating temperature of the flash tank | Numeric | Client data stored in |
| | temperature | if used in ° Fahrenheit (° F.) | | System Database |
| PSIG | Flash tank | Operating pressure of the flash tank if | Numeric | Client data stored in |
| | pressure | used. Psig (pounds per square inch | | System Database |
| | | gauge) | | |
| | Stripping gas | Yes or no question. Is a gas stream | Text | Client data stored in |
| | option | used to remove the hydrocarbons from | | System Database |
| | | the glycol vent stream? | | |
| | Stripping gas | Flow rate of the stripping gas stream, | Numeric | Client data stored in |
| | flow rate | scfm | | System Database |
| | Control device | Choose a control device as either a | Text | Client data stored in |
| | option | vent condenser or vapor incinerator, or | | System Database |
| | | choose no control device. | | |
| | Vent | Operating temperature of the vent | Numeric | Client data stored in |
| | condenser | condenser (if used) in ° F. | | System Database |
| | temperature | | | |
| | Vent | Operating pressure of the vent | Numeric | Client data stored in |
| | condenser | condenser (if used) in absolute | | System Database |
| | pressure | pressure, e.g. psia | | |
| | Incinerator | Average ambient air temperature for | Numeric | Selected from climatic |
| | ambient air | the location in ° F. | | data stored in System |
| | temperature | | | Library |
| | Excess oxygen | % excess oxygen used in combustion | Numeric | Provided by the |
| | | process if a vapor incinerator is chosen | | manufacturer of the |
| | | as a control device. | | combustion unit and |
| | | | | included in the System |
| | | | | Library |
| | Combustion | % efficiency of the vapor control | Numeric | Provided by the |
| | efficiency | incinerator unit. | | manufacturer of the |
| | | | | combustion unit and |
| | | | | included in the equipment |
| | | | | data base. |
| VOCs | Volatile | Measurement of emissions of VOC's | Numeric | Glycalc ® program output |
| | Organic | as tons per year from the Glycalc | | |
| | Compounds | Program Printout in tons/year | | |
| HAPs | Hazardous Air | Volumetric measurement of a group of | Numeric | Glycalc ® program output |
| | Pollutants | air constituents that have been | | or information gained from |
| | | determined by the Environmental | | the EPA speciation |
| | | Protection Agency (EPA) to be | | program for HAP's. |
| | | considered categorically hazardous to | | |
| | | health and the human environment. | | |
| | | Measured in tons/year | | |

21. The method of claim 12, wherein the mathematical database includes the following primary calculation formulas for calculating flash emissions caused by the transfer of higher pressure liquids from a process vessel to a storage tank of less pressure:
logRₛₜ=0.4896−4.9161logγₒₛₜ+3.496logγₛₚ+1.501logPₛₚ−0.9213logTₛₚ
and the Vasquez Beggs GOR Correlation.
$$\begin{matrix}GOR = C1 \times SG100 \times {( {P}_{str} + {P}_{atm} )}^{C2} \times {e}^{\frac{C3 \times °API}{{T}_{gas} °F + 460}} \\ SG100 = SG \times ( 1.0 + 5.912 \times {10}^{- 5} \times {T}_{gas} °F \times log \frac{{P}_{sep} + {P}_{atm}}{114.7}\end{matrix}$$

| Symbol | Name | Description | Type | Source |
|---|---|---|---|---|
| Rₛₜ | Stock Tank | The ratio of the volume of gas | Numeric | Calculated by Black |
| | Gas Oil | generated per barrel of oil produced as | | Oil GOR equation, |
| | Ratio (GOR) | a result of the pressure drop between | | 3.6.1 |
| | | the pressurized separator and the oil | | |
| | | storage (stock) tank. Units = volume | | |
| | | gas/volume oil, e.g standard cubic | | |
| | | feet/barrel | | |
| γₒₛₜ | Stock Tank | Measurement of the ratio of the weight | Numeric | Calculated using the |
| | Oil specific | of the oil relative to water at standard | | physical data of the |
| | gravity | temperature and pressure. E.g. units = | | materials being |
| | | lb/gal per lb/gal or SG = 6.5 lb/gal oil/ | | stored |
| | | 8.34 lb/gal water @ STP = 0.78 | | |
| γₛₚ | Separator | Measurement of the ratio of the weight | Numeric | Calculated using the |
| | specific | of the air relative to | | physical data of the |
| | gravity | | | gas being measured |
| Pₛₚ | Separator | The operating pressure of the vessel | Numeric | Measured at the |
| | pressure | used to separate the oil, water and gas | | equipment by the |
| | | in the produced fluid stream | | user |
| Tₛₚ | Separator | The operating temperature of the | Numeric | Provided by the |
| | temperature | separator measured in ° F. | | user from field |
| | | | | measurements |
| V_{MW} | Vapor | The weight of one mole (or | Numeric | Determined by |
| | Molecular | Avogadro's number of molecules) of | | reference or |
| | Weight | the gas being measured. | | measurement. May |
| | | | | use default value or |
| | | | | actual gas analysis. |
| C1, C2, | Vasquez | Constants calculated for the use in this | Numeric | Provided by |
| C3 | Beggs | relationship using stastical empirical | | reference to the |
| | Constants | data. Dimensionless | | relationship based |
| | | | | on degree API |
| | | | | gravity range of the |
| | | | | crude being stored. |
| SG | Specific | Same as γₛₚ or separator specific | Numeric | Calculated using the |
| | Gravity of | gravity as described above. | | physical data of the |
| | the gas | | | gas being measured |
| SG100 | Specific | A calculated quantity based on the | Numeric | Result of equation |
| | gravity of | temperature and pressure measured at | | 3.6.3 |
| | the gas | the separator referenced to 100 pounds | | |
| | referenced to | per square inch gauge (psig) pressure. | | |
| | 100 psig | | | |
| Pₛₜᵣ | Pressure | Pressure of the fluid stream as it leaves | Numeric | Measured in the |
| | of the | the separator or the separator pressure. | | field by the user. |
| | upstream | | | |
| | fluid | | | |
| Pₐₜₘ | Atmospheric | The measured pressure of ambient | Numeric | Measured at the |
| | pressure | conditions or in the atmosphere outside | | field location using |
| | | the separator. | | a barometer or by |
| | | | | default at ST&P. |
| T_{gas} | Gas temperature at | The measured temperature of the gas | Numeric | Measured at the |
| | the separator | stream in the separator | | field location by the |
| | | | | user. |
| Pₛₑₚ | Separator Pressure | The operating pressure of the separator | Numeric | Measured at the |
| | | measured in psig | | field location by the |
| | | | | user. |
| psig | Pounds per square | Pressure measurement in units of | Numeric | Measured with a |
| | inch gauge | pounds per square inch or in general | | pressure measuring |
| | | units-f/l². | | device at the |
| | | | | equipment site. |
| ° API | Degrees API gravity | The measured API gravity of the fluid | Numeric | Calculated using the |
| | | (crude) being measured as calculated | | physical data of the |
| | | by a standard equation which ratios the | | fluid. |
| | | specific gravity of the fluid to a | | |
| | | referenced standard. | | |
| ° F. | Degrees Fahrenheit | The standard temperature measurement | Numeric | Standard unit |
| | | using degrees Fahrenheit as a scale. | | |
| log | Logarithm | Mathematical relationship which | Text | Standard unit |
| | | equals the exponent value that the | | |
| | | number 10 would be raised to get that | | |
| | | same number. | | |

22. The method of claim 12, wherein the mathematical database includes the following primary calculation formulas for calculating loading loss emissions:
$${L}_{L} = 12.46 \frac{SPM}{T}$$

| Symbol | Name | Description | Type | Source |
|---|---|---|---|---|
| L_{L} | Loading losses- | The Volatile Organic | Numeric | Result of equation |
| | VOC | Compound (VOC) | | 3.7.1 |
| | | emissions quantity as | | |
| | | determined in the above | | |
| | | equation. | | |
| S | Saturation | Empirical quantity for | Numeric | AP-42 reference Table |
| | factor | calculation | | 5.2-1. Stored in |
| | | | | System Library. |
| P | True liquid | The true vapor pressure of | Numeric | By reference from |
| | vapor pressure of | the liquid being loaded | | AP-42 FIG. 7.1-5, |
| | the liquid being | which is the pressure at | | 7.1-6, 7.1-2. Stored in |
| | loaded | which the liquid is in | | System Library. |
| | | equilibrium with the | | |
| | | overhead vapors. Measured | | |
| | | in pounds per square inch | | |
| | | atmospheric (psia) | | |
| M | Vapor | The weight per mole of | Numeric | By reference from |
| | Molecular | gases being emitted, e.g | | AP-42 Table 7.1-2. |
| | Weight | lb/lb mole. One mole = | | Stored in System |
| | | weight of 10²³ molecules | | Library. |
| | | (Avogadro's number) of the | | |
| | | gas or 359 standard cubic | | |
| | | feet. (SCF) | | |
| T | Bulk | The temperature of the | Numeric | Supplied from the |
| | Liquid | liquid being loaded in °R | | tank calculation data. |
| | Temperature | (Rankine) = °F. + 460. | | |

23. The method of claim 12, wherein the mathematical database includes the following primary calculation formulas for calculating emission fees:
$$\sum Emissions \frac{tons}{year} \times \$ per ton = Annual Emissions Fee$$

| Symbol | Name | Description | Type | Source |
|---|---|---|---|---|
| $ | Price per ton | The dollar price per tons of | Numeric | Established by law |
| | | emissions as established by | | |
| | | the particular state of | | |
| | | operation | | |
| NOx | Nitrous Oxides | Nitrous oxide emissions | Numeric | Calculated |
| CO | Carbon | Carbon monoxide emissions | Numeric | Calculated |
| | Monoxide | | | |
| SO₂ | Sulfur dioxide | Sulfur dioxide emissions | Numeric | Calculated |
| PA or PM₁₀ | Particulates | Particulate emission from fuel | Numeric | Calculated |
| | | combustion | | |
| VOCs | Volatile Organic | VOC emissions | Numeric | Calculated |
| | Compounds | | | |
